(19) United States
(12) Patent Application Publication
(10) Pub. No.: US 2021/0002955 A1
(43) Pub. Date: Jan. 7, 2021

(54) SCREEN WITH MARKER

(71) Applicant: Aedes Technologies, Seattle, WA (US)

(72) Inventor: Jonathan Seth Clarren, Seattle, WA (US)

(21) Appl. No.: 16/816,251

(22) Filed: Mar. 11, 2020

Related U.S. Application Data
(60) Provisional application No. 62/816,801, filed on Mar. 11, 2019.

(51) Int. Cl. E06B 9/52; B44C 1/17

(52) U.S. Cl. CPC E06B 9/52; E06B 2009/525; E06B 2009/524; B44C 1/1712

(57) ABSTRACT

Products and devices are described for displaying a visible marker on a screen. Density patterns create the visible marker. The present disclosure also describes methods for manufacturing or displaying the visible marker on the screen.

### CROSS REFERENCE TO RELATED APPLICATIONS

This application is a continuation of and claims priority to U.S. Application Ser. No. 62/816,801, entitled “SCREEN WITH MARKER,” filed Mar. 11, 2019, which is incorporated herein in its entirety.

### BACKGROUND

Screen doors and windows are traditionally used to enclose an interior space. The screen material allows the exterior air to pass through the screen into the interior space, while also preventing debris, insects and other undesirable objects from entering the interior space. However, screen doors and windows can be difficult to see, which can result in people and animals walking into them. This can be a hazard that results in injury to the person or animal and damage to the screen door or window. It is with respect to these considerations and others that the disclosure made herein is presented.

### SUMMARY

In general, the present disclosure describes products, systems, and techniques for providing an indication to a user of the presence of a screen. In some examples described herein, the screen is configured to display a visible marker that can provide a visual indication to the user that the screen is present. In some embodiments, the screen may be mounted to a door or window. However, it should be appreciated that this screen may be used in any configuration where visual detection of a screen may be beneficial.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 depicts a perspective view of a structure that is partially enclosed with screens displaying visible marker.

FIG. 2 depicts a top-down view of plain weave pattern.

FIG. 3 illustrates an embodiment of a screen displaying visible markers.

FIG. 4 illustrates an embodiment of a screen displaying visible markers.

FIG. 5 illustrates an embodiment of a screen displaying visible markers.

FIG. 6 illustrates an embodiment of a screen displaying visible markers.

FIG. 7 illustrates an embodiment of a screen displaying visible markers.

FIG. 8 illustrates an example process for imprinting a marker on a screen product.

FIG. 9 illustrates an example of part of a process for imprinting a marker on a screen product.

FIG. 10 illustrates an example of part of a process for imprinting a marker on a screen product.

FIG. 11 illustrates an example of part of a process for imprinting a marker on a screen product.

FIG. 12 illustrates an operator's view of part of a process for imprinting a marker on a screen product.

FIG. 13 illustrates a side view of part of a process for imprinting a marker on a screen product.

FIG. 14 illustrates a view of part of a process for imprinting a marker on a screen product.

FIG. 15 illustrates an example of part of a process for imprinting a marker on a screen product.

FIG. 16 illustrates a view of part of a process for imprinting a marker on a screen product.

FIG. 17 illustrates a view of part of a process for imprinting a marker on a screen product.

FIG. 18 illustrates an embodiment of screens displaying visible markers.

FIG. 19 illustrates an embodiment of screens displaying visible markers.

FIG. 20 illustrates an embodiment of screens displaying visible markers.

FIG. 21 illustrates an embodiment of screens displaying visible markers.

FIG. 22 is a flowchart depicting an example procedure in accordance with the present disclosure;

FIG. 23 is an example computing device in accordance with the present disclosure.

### DETAILED DESCRIPTION OF ILLUSTRATIVE EMBODIMENTS

Residential and commercial structures often have screens that are mounted to the exterior of the structure. The screens are typically used to serve several purposes. One purpose might be to prevent unwanted debris, such as insects, leaves, etc. from entering an interior portion of the structure. A second purpose might be to allow exterior air to enter the interior portion of the structure. In this manner, the screen may allow the desirable features of an outdoor environment to enter the interior portion of the structure. It should also be appreciated that screens may be used in interior portions of structures for many purposes that will be discussed herein.

In some embodiments, screens may comprise a mesh interface. The mesh interface may not only serve the functions as previously described, but the mesh interface may also allow a user to see through the screen to visually detect the outdoor environment or the environment beyond the screen. The user includes, but is not limited to, any human being, animal, or any other living being capable of detecting light and converting light into electro-chemical impulses in neurons. Because the mesh may be configured to have a nearly invisible appearance, the screen may be difficult to visually detect by the user. In this manner, the user may inadvertently contact the screen, which can cause harm or injury to the user and damage to the screen.

Many screening products for doors and windows do not have a screen material that was designed to prevent screen door accidents or was designed to make people visually aware of the presence of screen. In general, it is difficult for people to see a screen mesh product when light interacts with the screen mesh. This can occur when the person interacting with the door experienced a significant amount of light from the other side of the screen. For example, this occurs when a person in a dark house approaches a screen door from inside the house to the outside during a bright day, or when a person is outside in the dark and approaches a brightly lit house or enclosure. Many accidents occur in interactions where the amount of light behind the person was less than the amount of light moving through the screen towards the interaction.

In various embodiments, changing the density of the weave, by increasing the density of the warp ends in specified areas of the woven structure, or by adding material to change the density with respect to other areas of the screen, provide ways to provide screen visibility.

The various features and processes described above may be used independently of one another, or may be combined in various ways. All possible combinations and subcombinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

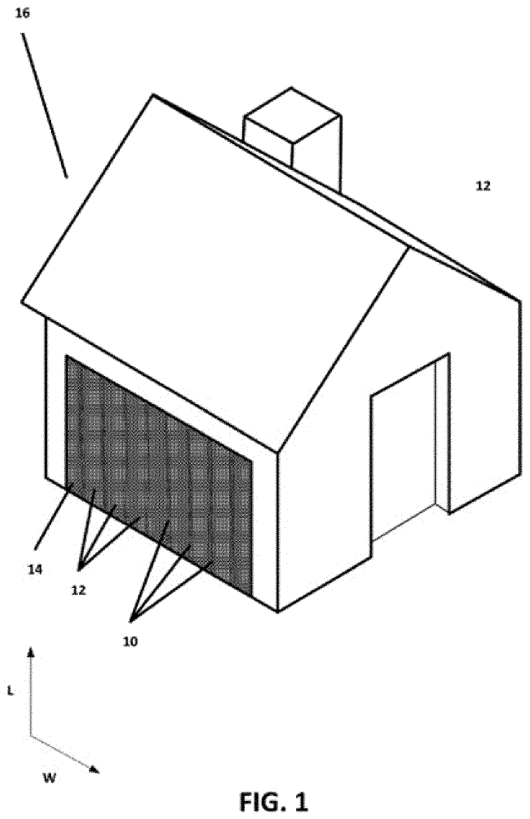

FIG. 1 shows a perspective view of a structure 16 that is partially enclosed by a screen 14. Screen 14 may further include one or more ground patterns 12 and one or more visible markers 10, which may be configured to be visible to a user so that the presence of the screen can be determined. In the embodiment as shown in FIG. 1, screen 14 is mounted along the exterior portion of the structure 16. Specifically, in the embodiment shown in FIG. 1, screen 14 may be configured to be removably mounted to a door and/or window frame. Screen 14 may further be configured to display one or more visible markers 10 and one or more ground patterns 12. In this manner, ground pattern 12 defines a first pattern that is configured to achieve a first transparency. As well, visible marker 10 defines a second pattern configured to achieve a second transparency. The second transparency may be configured to be more visible to the user and in effect, it may be easier to visually detect the overall presence of the screen 14 by the user. In addition, the second transparency may also be easier to visually detect by the user because the second transparency may create a visible contrast when positioned adjacent to the first transparency.

It should be appreciated that the structure 16 is not limited to the structure as disclosed in FIG. 1. In other embodiments, the structure 16 may be, but is not limited to any of the following: a commercial structure; an industrial structure; a temporary structure, such as a tent or shelter; a storage structure, such as a shed; an outdoor feature, such as a pergola, arbor, windbreak for vegetation, or plant covering; an automobile; a batting cage; or any other structure that is at least partially enclosed by a screen or contains at least a portion of a screen within the interior.

In addition to screen 14 partially enclosing a structure, there are many other applications. Screen 14 may be used along any interior or exterior portion of any of the previously mentioned structures or contemplated structures. For example, screen 14 may be a fire screen that is positioned in front of a fireplace. In other embodiments, screen 14 may be a folding screen, such as a Japanese decorative folding screen. In other embodiments, screen 14 may cover a windshield of an automobile. In other embodiments, screen 14 may be used in a confessional to separate a priest from a penitent. In yet other embodiments, screen 14 may be a smoke screen. In still other embodiments, screen 14 may be used along any interior or exterior portion of a tent. In general, it should be appreciated that the screen 14 may be used in any application within the interior or exterior of any structure where it may be beneficial to alert the user of the presence of the screen 14.

Furthermore, the embodiment in FIG. 1 shows the screen 14 as partially enclosing the structure 16. In other embodiments, the screen 14 may completely enclose the structure 16. In addition, it should also be appreciated that the screen 14 may be positioned at any location on the structure 16. In some embodiments, one or more screens 14 may be positioned at a top portion of the structure 16 along the first direction L. For example, the structure 16 may have one or more screens 14 along the roof of the structure 16 serving as skylights. In this manner, the screen 14 may be configured to have one or more visible markers 10, which may alert a bird or any other living being of the presence of the screen.

A drawback of screening products for doors and windows is that they are not fitted with a screen material that is designed to prevent screen accidents. Generally, the screen material is not designed to make people visually aware of the presence of the screen. However, people are not able to see a screen product effectively when light interacts with the screen. This occurs when the person interacting with the door/window experiences a significant amount of light from the other side of the screen. Therefore, a more effective screen product that is visually perceptible under various lighting conditions and thus designed to prevent screen accidents is needed.

Objectives of the present disclosure include a screen product with a noticeable difference between transparencies within the surface of the screen. It is the isolated occurrence of denser motifs within a surface of otherwise increased transparency that creates a visible difference between material areas, thereby alerting a person of the screen's presence. This can be achieved, for example, by weaving denser areas to create isolated stripes, by applying embroidery in isolated motif areas, and applying designs in selected areas. The disclosure does not aim to provide a uniform distribution of transparency variances across a surface. where a uniform product is created whereby the ratio of transparency differences is the same across the entire woven surface, providing equal amounts of both air flow and sun blockage. The present disclosure is directed to the isolated occurrence of denser areas within an otherwise transparent mesh that creates a visible difference between material areas, thereby alerting a person of the mesh's presence. The incorporation of different transparency areas in a screen product produces advantages that are not readily apparent or obvious as compared to other possible modifications to a screen product.

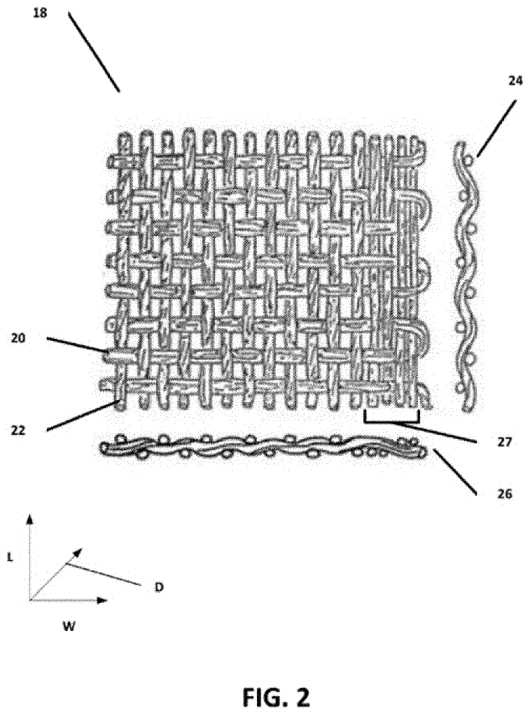

FIG. 2 illustrates a plain weave, which is a type of mesh pattern that may be used in the screen 14 that further defines the visible marker 10 and ground pattern 12. FIG. 2 shows plain weave 18, as further including filling threads 20, warp threads 22, filling cross section 24, warp cross section 26, and selvage 27. In the embodiment shown in FIG. 2, filling 20, also known as weft, may be a thread or any suitable material that runs horizontal or widthwise along a second direction W. One thread of filling 20 may be known as a pick. In FIG. 2, warp threads 22 may be the thread that runs vertical or longitudinal along a first direction L. Accordingly, one warp thread 22 may be known as an end. In the plain weave embodiment shown in FIG. 2, one repeat of a plain weave may be comprised of two ends and two picks.

It should also be appreciated that the filling threads 20 and warp threads 22 may extend along other directions besides first and second directions L and W. In some embodiments, the warp threads 22 extend along a third direction D (as shown in FIG. 2). The third direction D may extend in any direction along the 90° between first and second directions L and W. In these embodiments, the filling threads 20 may extend perpendicular to the third direction D. In this manner, the threads of the screen 14 may be configured in any direction (L, W, or D).

While thread is described above, it should be appreciated that any type of suitable material that is able to be threaded to form a pattern may be used. For example, the thread may be made from a material comprising stainless steel, vinyl coated fiberglass yarn, or fiberglass. It should also be appreciated that any size of thread material may be used to form the mesh of screen 14. In some embodiments, the thread is 0.006 inches (0.01524 centimeters) to 0.011 inches (0.02794 centimeters) in diameter. It should also be appreciated that the term thread can refer to monofilament, single ply, plied, and textured yarn.

While FIG. 2 illustrates a plain weave embodiment, it should be noted that this is only one type of many weaves that may be used to configure screen 14, visible marker 10, and ground pattern 12. It should be appreciated that any of the following types of weaves may be used, such as a crepe weave, rib weave, matt weave, basket weave, twill weave, satin weave, or any type of weave that is able to be configured to visually alert a user of the presence of the screen. For example, a crepe weave can be configured such that there is no repeat pattern and instead is a random pattern that can be reversible.

It should also be appreciated that the person having ordinary skill in the art may also refer to the first and second transparencies as the first and second cover factors. The first and second cover factors may be defined by a measurement of the percentage area covered by the material. The cover factor may depend upon the textile or fabric construction and the cover factor may change depending on material density, the type of weave pattern, and the profile of the material. To further illustrate cover factor, patterns with a low cover factor may have a high percentage of open area, which may make them more difficult to visually detect by the user. In accordance, patterns with a high cover factor may have a low percentage of open area, which may make them less difficult to visually detect by the user.

To create a density-based imprint on a screen product, embodiments are disclosed that do not use a printing laser or ink jet printing process. In an embodiment, various types of materials can be cut and can be heat set and bonded through the heating and/or melting of the fabric and “decal” together. Adhesive is not needed because through heat, the two materials “Screen Mesh” and “Decal” are chemically bonded together through melting the two products together. Various decal materials can be used, that may be typically comprised of vinyl brands such as Easy Weed (Heat Transfer Vinyl or garment industry Vinyl is a polyurethane, ready-to-cut custom garment decoration film. Although commonly referred to as a heat transfer or t-shirt vinyl it is actually a heat transfer film since it has no adhesive backing. Heat Transfer Vinyl is adhered to the substrate by a heat press) can be used to achieve the result. In other embodiments, OLED polymers may be used. For example, thin OLEDs or polymer-OLEDs made from polymer (large-molecule) materials may be used.

In one embodiment, a vector-based graphic can be generated and vector-based cut file graphics can be exported to a “Plotter machine.” An input file may include a suitable graphics file such as in the JPEG format and may have 300 DPI resolution at 1600×1600 pixels.

A plotter may be a computer vector graphic printer that produces a hard copy of the output based on instructions from the graphic art file. Plotters are widely used to print designs of items such as cars, ships, and buildings on paper using a pen. Plotters are different than a printer in that they are more precise and are typically used in engineering, where precision is desired. Plotters are widely used in engineering projects because they can produce continuous lines, in contrast to ordinary printers that conventionally draw lines using closely spaced dots. Plotters come in various forms. Most plotters use a pen to draw the design onto paper. However, a 3-D plotter (cutting plotter) uses knives to cut out a piece of material based on instructions from the computer. The object to be cut is placed on the flat surface in front of the plotter. The computer sends cutting dimensions and designs for the plotter to produce a precisely carved design, and potentially repeat the cutting process on hundreds of objects, producing identical copies of the same design.

A plotter is also known as a graph plotter. To achieve a Kiss Cut (Kiss Cut stickers include light cuts within the border of your stickers. When stickers are created with kiss cuts, it means they can be peeled out of the backing material and the backing material remains. Multiple Kiss Cuts on one sticker are usually called a “sticker sheet”.)

This decal needs to be weeded, which means the material that is not a part of the design must be peeled off of the backer material so that all that remains is the desired design. At this point, the design can be imprinted onto the substrate. In one embodiment, a tool referred to as a heat press can be used. (A heat press is a machine engineered to imprint a design or graphic on a substrate, such as a t-shirt, with the application of heat and pressure for a preset period of time. One most common type of heat press employs a flat plate to apply heat and pressure to the substrate.)

In an embodiment, the material is a screen mesh. Since existing tools and materials that are currently available are tailored to the T-Shirt industry, existing tools are not typically configured to be applicable to screen products and their larger sizes and textures. In one embodiment, existing tools from the textile industry may be modified to roll, measure, and package fabrics and integrate this technology with a heat press, so that the mounting of the heat press can be mounted onto the measuring machine. By modifying existing methods and tools and adapting them to the screen product, graphic results in the open mesh fabric can be produced that are visible on both sides of the fabric under various light levels. The result can be used for safety-based markers as described herein. Additionally, the imprinted designs can also be useful for company branding, artistic, applications, decorative applications, and for advertisements. The disclosed process can be used in applying graphics not only into screen mesh intended to be used in windows and doors, but also for shade and rigid curtain materials. By implementing the described embodiments, the material can be rolled up for use in various industry standards for retractable, doors, shades, and curtain products.

The disclosed process can be used to generate specific designs for specific clients, or it can be used to make specific products that the company brands and markets to various markets to allow consumers to incorporate decorative and adornment designs in their screening material choices.

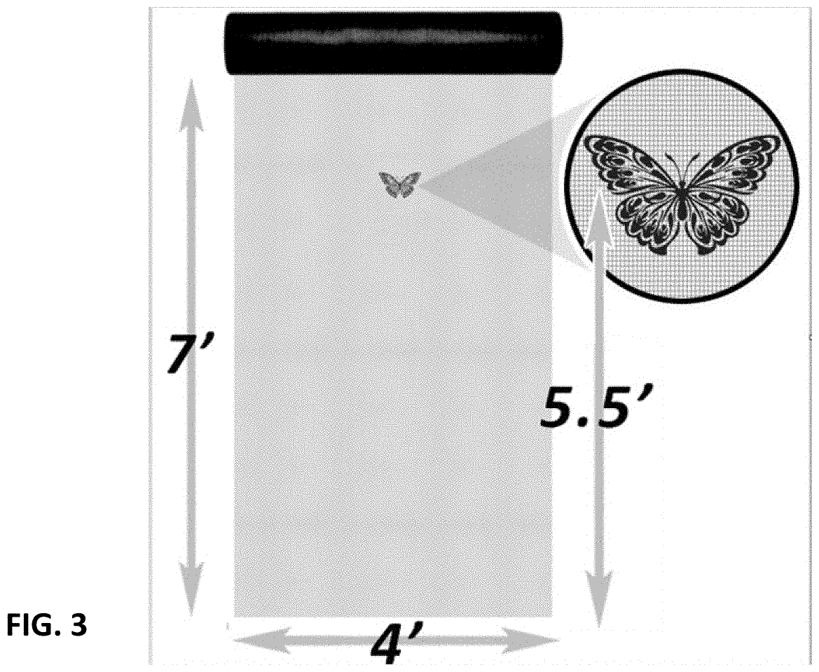

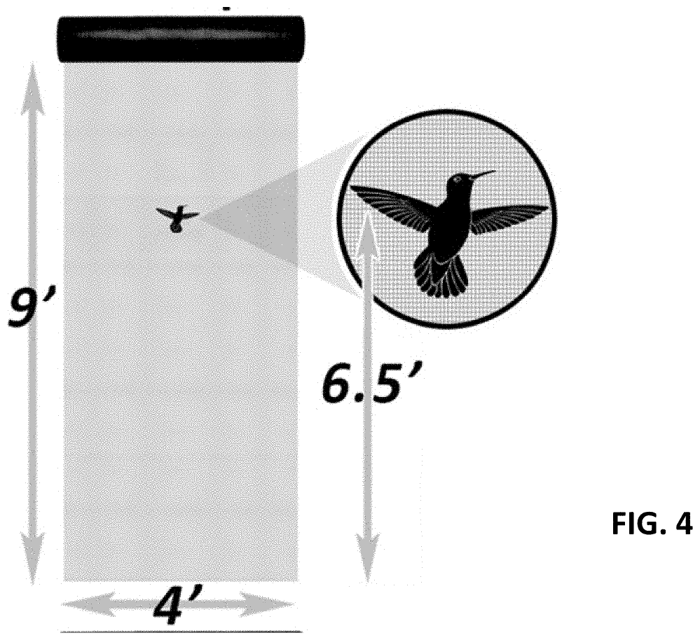

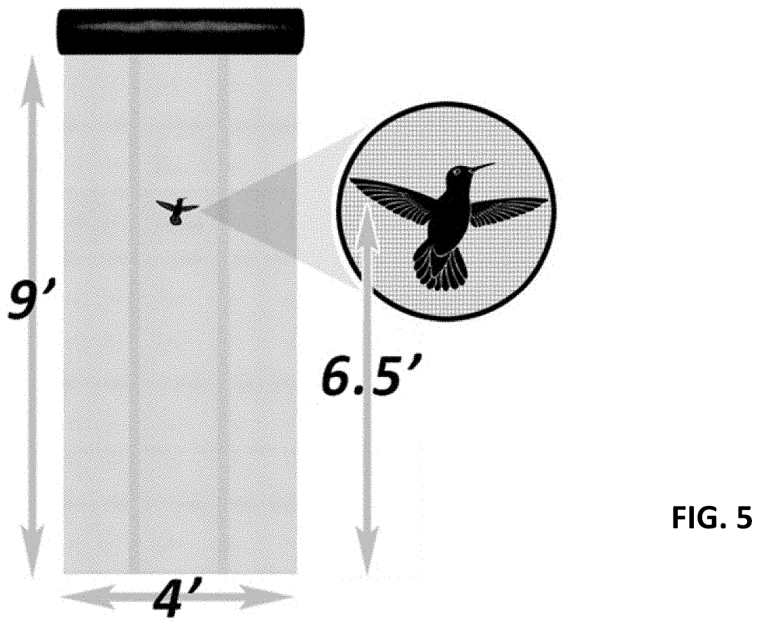

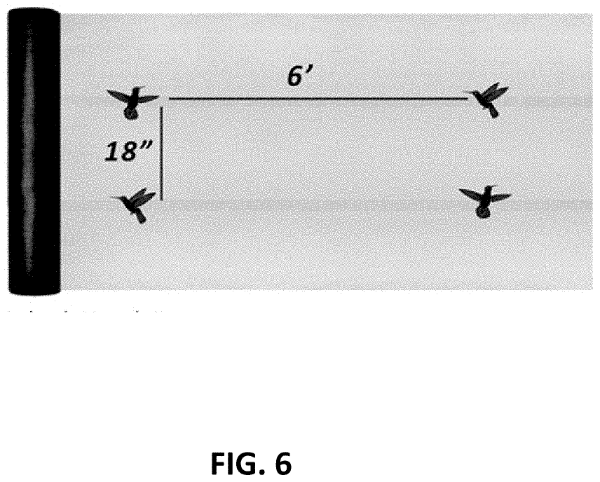

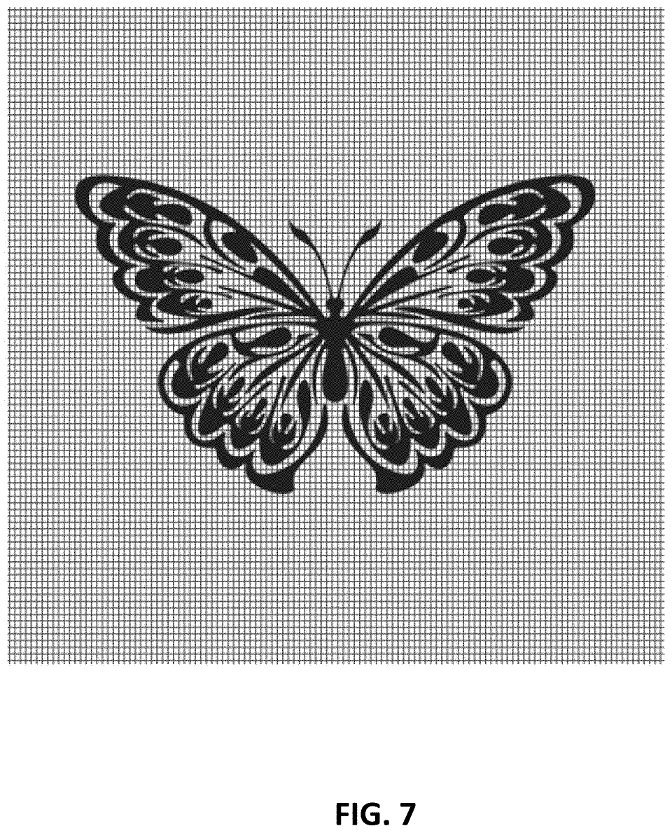

In one embodiment, the “Decals” may be set roughly in the middle of a 4′ piece of fabric at different lengths depending on the size of the target door or window. Typically, heights of a 7′ door or a 9′ door may be used. In an embodiment, the Decal safety marker may be approximately 5.5′ in the fabric, although various design can be imprinted in different places on the fabric depending on client preferences. The location of the decal may be selected that it is optimized for the client to move the decal around as much as possible when placing in the door or window. reference layout image examples. FIGS. 3-6 show various examples for decal layouts. FIG. 7 shows one example decal.

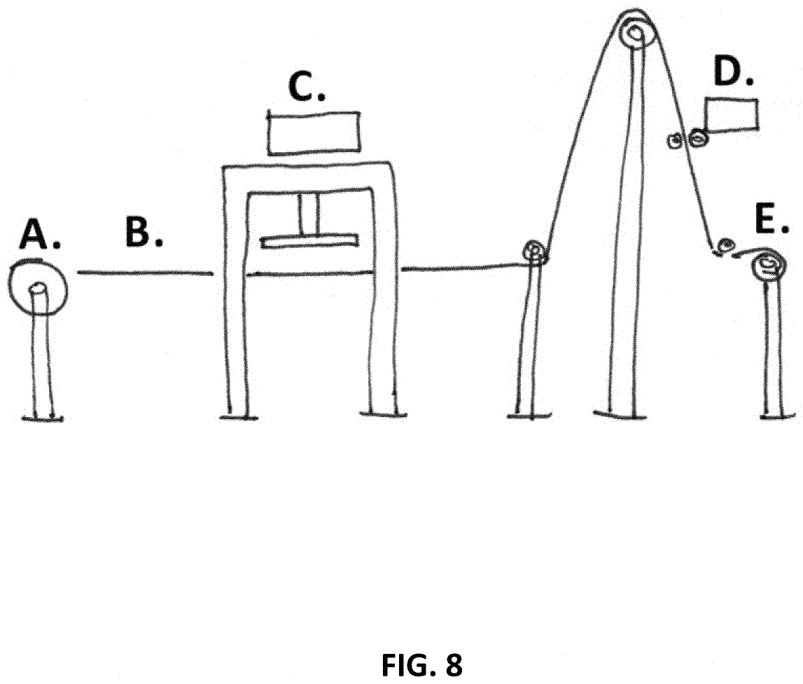

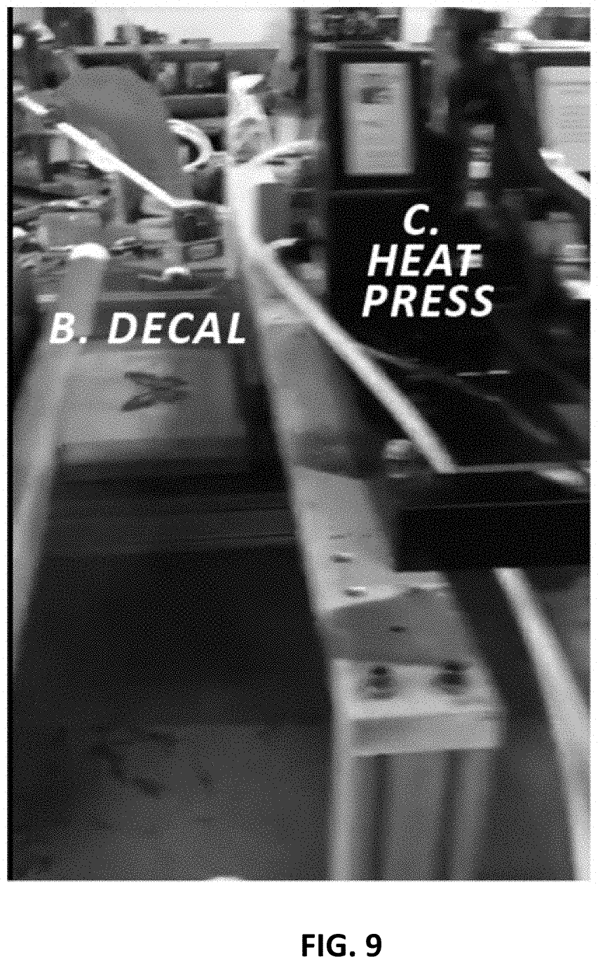

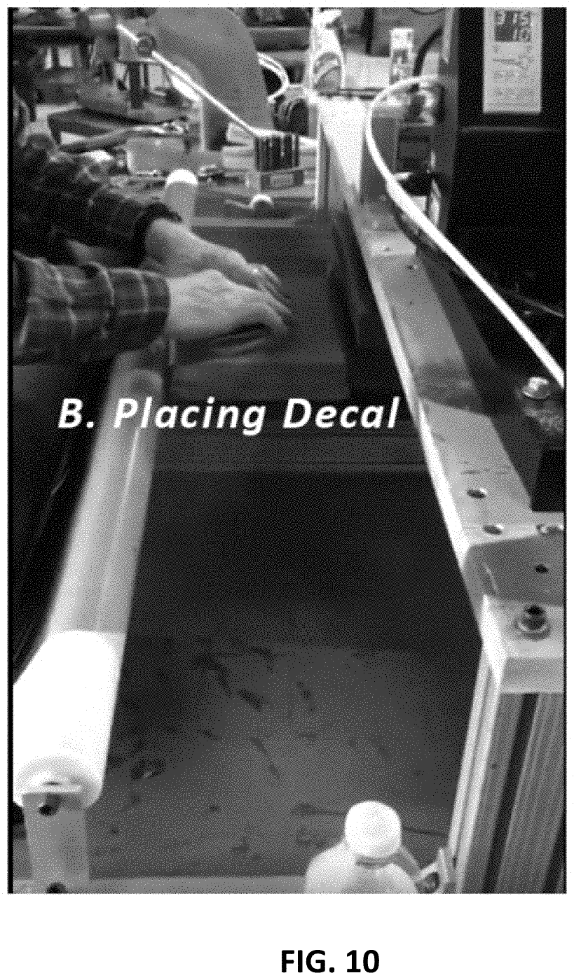

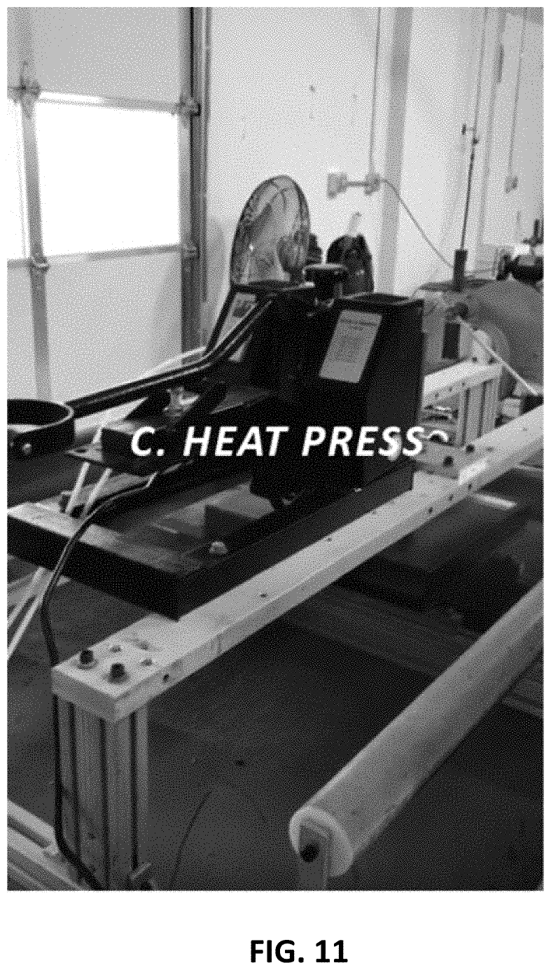

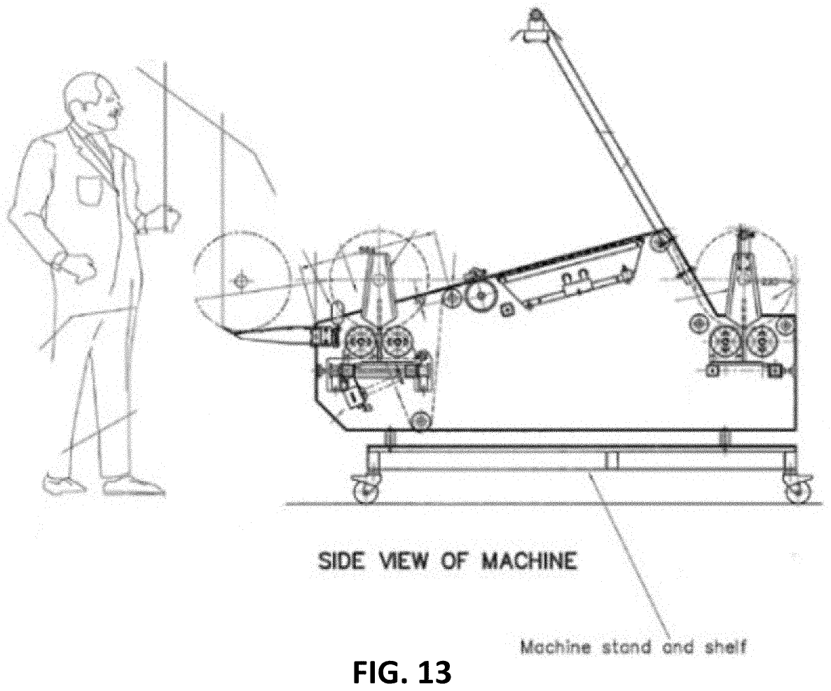

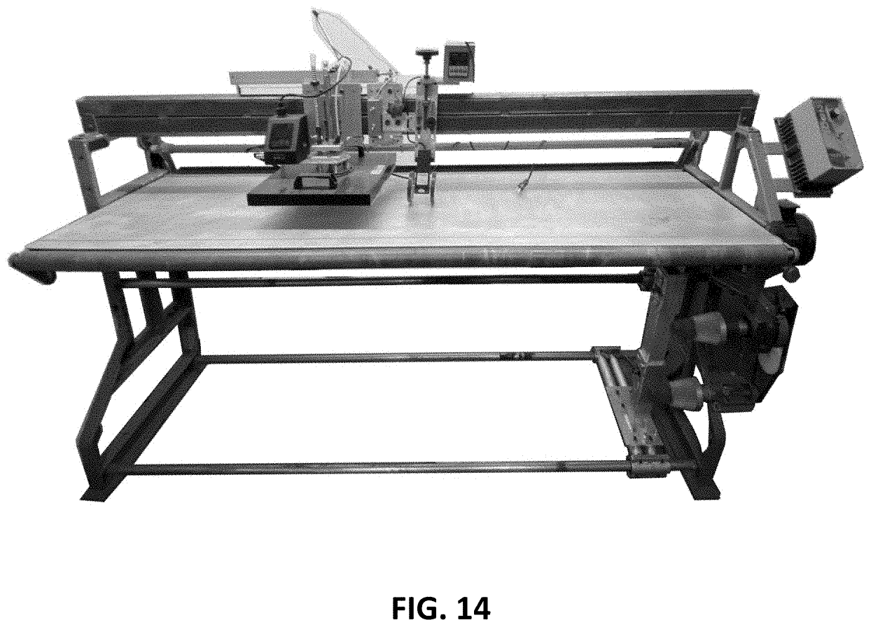

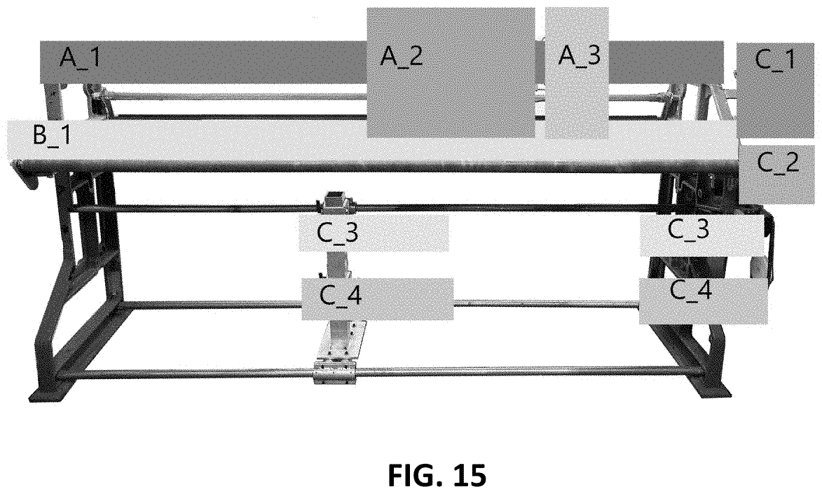

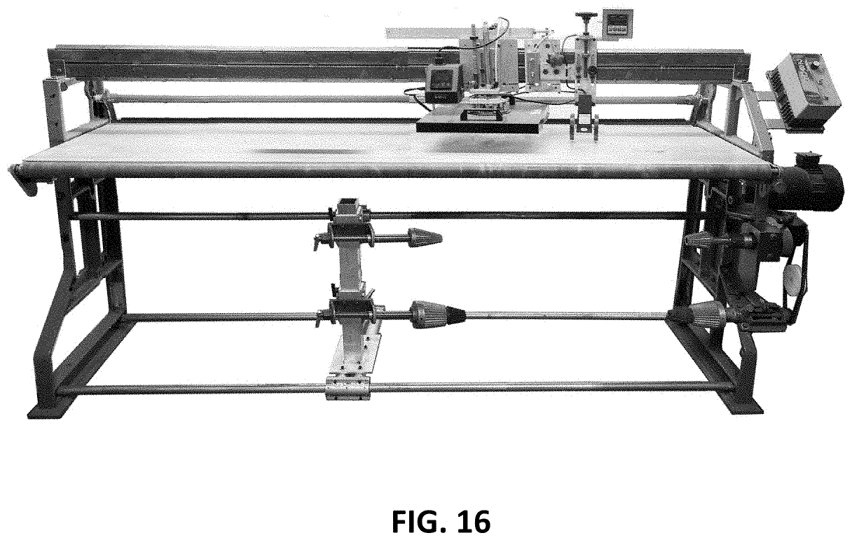

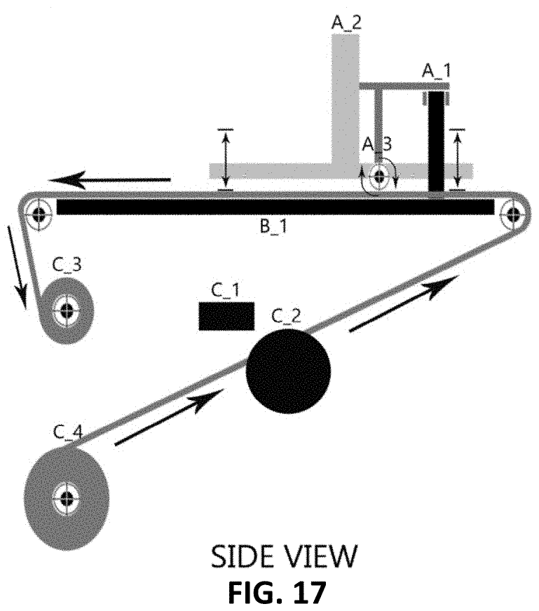

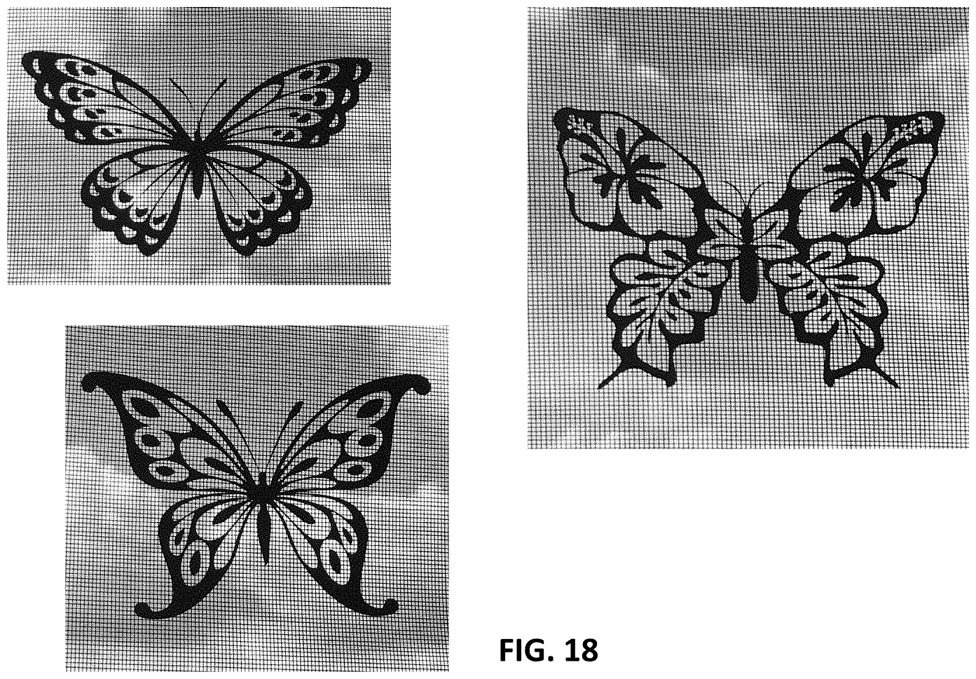

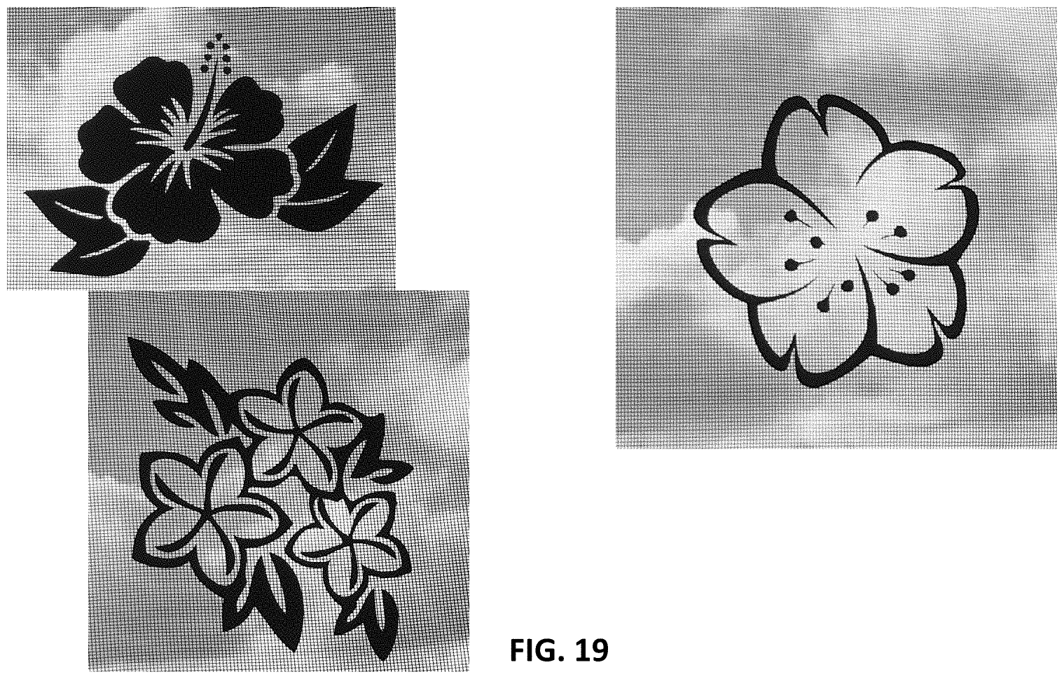

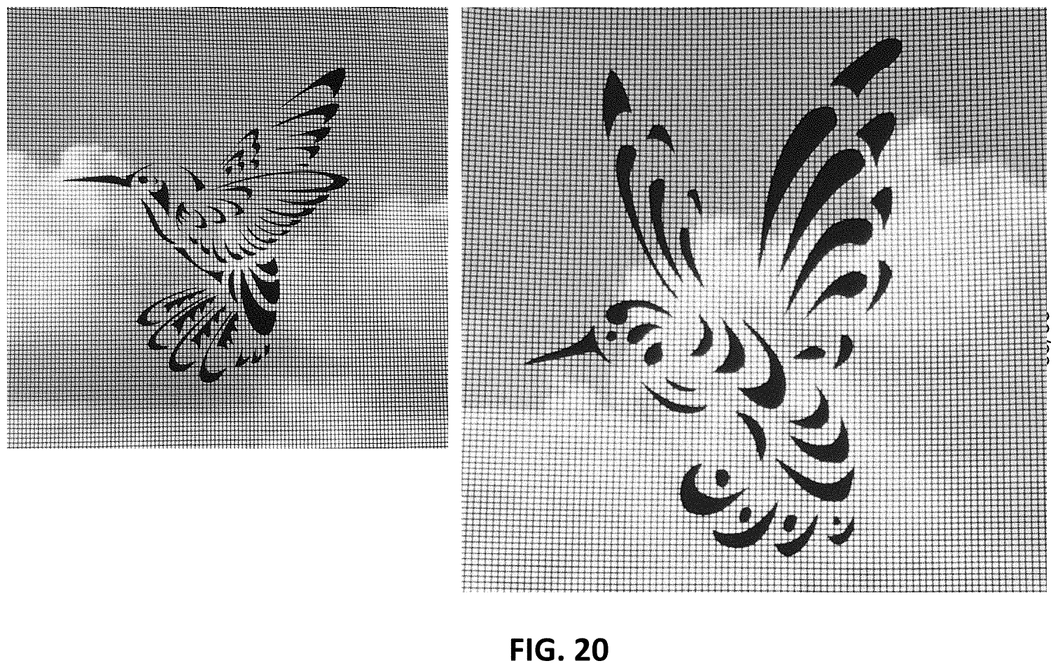

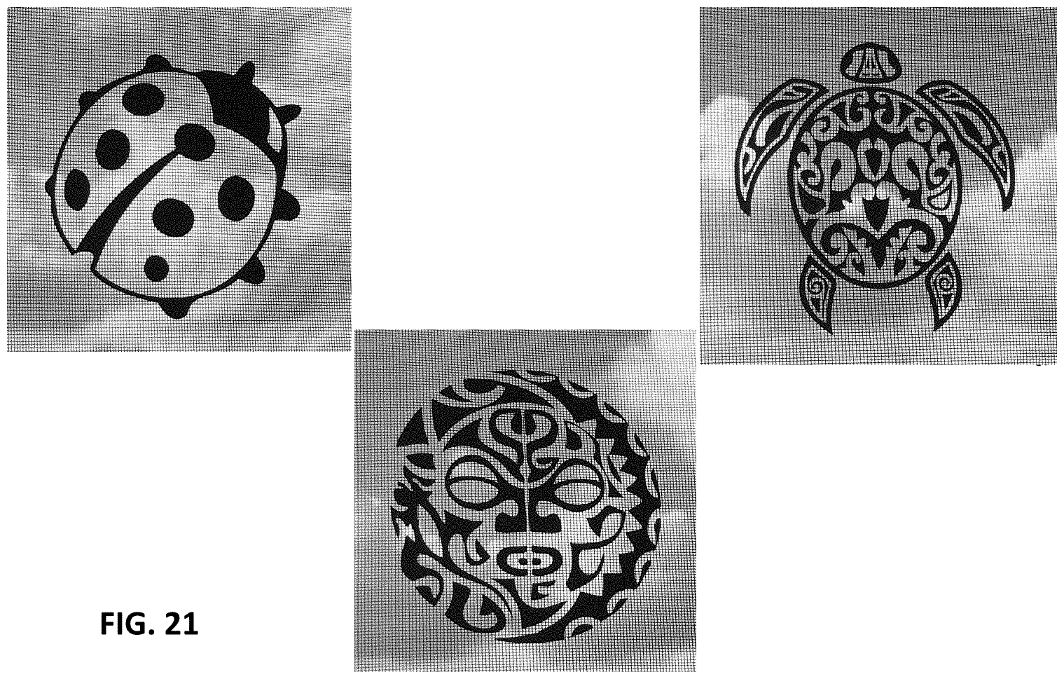

FIG. 8 describes one example procedure for implementing the embodiments described herein. Step A describes starting the roll of an unprocessed screen mesh. Step B describes placement of the decal to be heat pressed onto the fabric. Step C describes the heat press. Step D describes a measuring device that is configured to determine the amount of material that will be used. Step E describes the final roll-up shaft where material is rolled up, cut, and released to be packaged for the client. FIGS. 9-17 illustrates various aspects of these processes. FIG. 15 illustrates the following components: A_1 Rail for Heat Press and Measuring device allowing both devices to travel together horizontally across B_1 Heat Press Platen; A_2 Heat Press; A_3 Fabric Measuring Device; B_1 Heat Press Platen; C_1 Motor Control; C_2 Motor used to move fabric across B_1; C_3 Top winder receiver for finished fabric post fabric treatment; C_4 Bottom winder dispenser of source fabric fed onto B_1 and received by C_3. FIG. 17 illustrates A_1 Rail for Heat Press and Measuring device allowing both devices to travel together horizontally across B_1 Heat Press Platen; A_2 Heat Press; A_3 Fabric Measuring Device; B_1 Heat Press Platen; C_1 Motor Control; C_2 Motor used to move fabric across B_1; C_3 Top winder receiver for finished fabric post fabric treatment; C_4 Bottom winder dispenser of source fabric fed onto B_1 and received by C_3. FIGS. 18-21 show various examples for decal imprints.

In an embodiment, a screen product may comprise:

a screen configured to be removably received by a frame, the screen comprising:

a plurality of longitudinal threads that extend along a first direction; and

a plurality of widthwise threads that extend along a second direction that is perpendicular to the first direction;

an imprint;

wherein the longitudinal threads and the widthwise threads are configured to achieve a first transparency and the imprint has a variation in density that achieves a second transparency that is different from the first transparency;

wherein the first and second transparencies are operable to produce a visually perceptible difference between the first and second transparencies when the screen product is viewed; and

wherein the screen product is configured to be used in a door or window opening to provide a visible indication of presence of the screen product due to differences in light attenuation by the first and second transparencies and not due to color or hue of the screen product.

In an embodiment, the screen product further comprises a frame that defines an exterior portion.

In an embodiment, the imprint has a variation in density.

In an embodiment, the imprint is bonded to the screen using a heat set and bonded.

In an embodiment, the imprint is chemically bonded to the screen.

In an embodiment, a screen product comprises:

a screen configured to be removably received by a frame, the screen comprising:

a plurality of longitudinal threads that extend along a first direction; and

a plurality of widthwise threads that extend along a second direction that is perpendicular to the first direction, wherein the longitudinal threads and the widthwise threads are weaved to form a mesh that includes a first pattern configured to achieve a first transparency, and wherein the mesh includes an imprint that is different from the first pattern and configured to achieve a second transparency that is different from the first transparency;

wherein the first and second transparencies are operable to produce a visually perceptible difference between the first and second transparencies when the screen product is viewed; and

wherein the screen product is configured to be used in a door or window opening to provide a visible indication of presence of the screen product due to differences in light attenuation by the first and second transparencies and not due to color or hue of the screen product.

In an embodiment, an apparatus for preparing a screen product includes:

a screen configured to be removably received by a frame, the screen comprising:

a plurality of longitudinal threads that extend along a first direction; and

a plurality of widthwise threads that extend along a second direction that is perpendicular to the first direction, wherein the longitudinal threads and the widthwise threads are weaved to form a mesh that includes a first pattern configured to achieve a first transparency;

an imprint that is different from the first pattern and configured to achieve a second transparency that is different from the first transparency;

wherein the first and second transparencies are operable to produce a visually perceptible difference between the first and second transparencies when the screen product is viewed; and

wherein the screen product is configured to be used in a door or window opening to provide a visible indication of presence of the screen product due to differences in light attenuation by the first and second transparencies and not due to color or hue of the screen product;

the apparatus comprising a heat press coupled to a measuring device;

the apparatus configured to:

receive an amount of unprocessed screen mesh;

receive a decal;

measure an amount of the unprocessed screen mesh; and

pressurize the heat press on the amount of the unprocessed screen mesh and a decal placed between the unprocessed screen mesh and the heat press to produce a processed screen mesh;

wherein the heat press is usable to bond the decal to the amount of unprocessed screen mesh.

In an embodiment, the apparatus is further configured to roll the processed screen mesh.

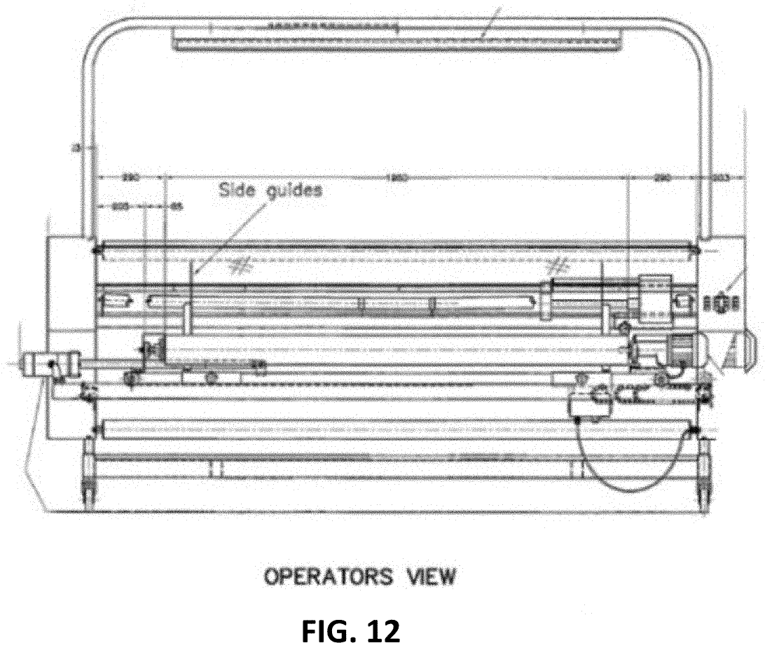

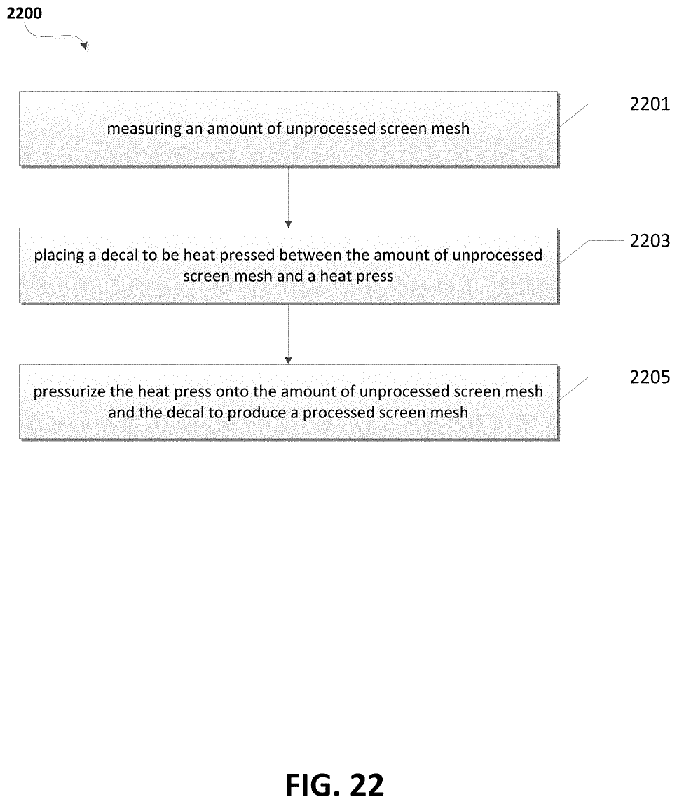

Turning now to FIG. 22, illustrated is an example operational procedure for generating a screen product in accordance with the present disclosure. The operational procedure may be implemented using an apparatus, for example the apparatus depicted in FIGS. 12-17. Referring to FIG. 22, operation 2201 illustrates measuring an amount of unprocessed screen mesh.

Operation 2201 may be followed by operation 2203. Operation 2203 illustrates placing a decal to be heat pressed between the amount of unprocessed screen mesh and a heat press.

Operation 2203 may be followed by operation 2205. Operation 2205 illustrates pressurizing the heat press onto the amount of unprocessed screen mesh and the decal to produce a process screen mesh.

In an embodiment, the heat press is operable to bond the decal to the amount of the unprocessed screen mesh.

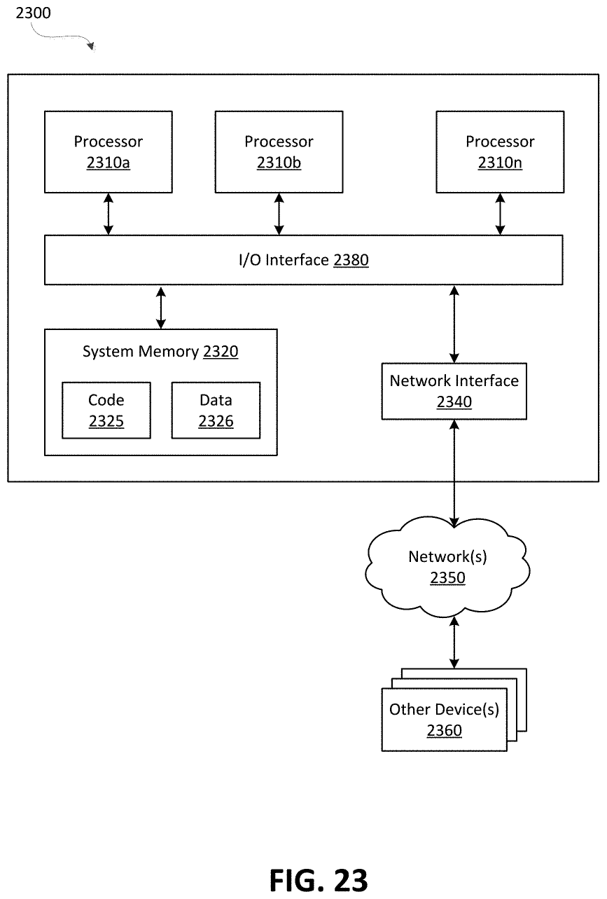

In some embodiments, a computing device that implements a portion of one or more of the technologies described herein, including the techniques to control aspects of the apparatus described in FIGS. 12-17, may include a general-purpose computer system that includes or is configured to access one or more computer-accessible media. FIG. 23 illustrates such a general-purpose computing device 2300. In the illustrated embodiment, computing device 2300 includes one or more processors 2310a, 2310b, and/or 2310n (which may be referred herein singularly as “a processor 2310” or in the plural as “the processors 2310”) coupled to a system memory 2320 via an input/output (I/O) interface 2330. Computing device 2300 further includes a network interface 2340 coupled to I/O interface 2330.

In various embodiments, computing device 2300 may be a uniprocessor system including one processor 2310 or a multiprocessor system including several processors 2310 (e.g., two, four, eight, or another suitable number). Processors 2310 may be any suitable processors capable of executing instructions. For example, in various embodiments, processors 2310 may be general-purpose or embedded processors implementing any of a variety of instruction set architectures (ISAs), such as the x236, PowerPC, SPARC, or MIPS ISAs, or any other suitable ISA. In multiprocessor systems, each of processors 2310 may commonly, but not necessarily, implement the same ISA.

System memory 2320 may be configured to store instructions and data accessible by processor(s) 2310. In various embodiments, system memory 2320 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 2320 as code 2325 and data 2326.

In one embodiment, I/O interface 23230 may be configured to coordinate I/O traffic between the processor 2310, system memory 2320, and any peripheral devices in the device, including network interface 2340 or other peripheral interfaces. In some embodiments, I/O interface 23230 may perform any necessary protocol, timing, or other data transformations to convert data signals from one component (e.g., system memory 2320) into a format suitable for use by another component (e.g., processor 2310). In some embodiments, I/O interface 23230 may include support for devices attached through various types of peripheral buses, such as a variant of the Peripheral Component Interconnect (PCI) bus standard or the Universal Serial Bus (USB) standard, for example. In some embodiments, the function of I/O interface 23230 may be split into two or more separate components. Also, in some embodiments some or all of the functionality of I/O interface 23230, such as an interface to system memory 2320, may be incorporated directly into processor 2310.

Network interface 2340 may be configured to allow data to be exchanged between computing device 2300 and other device or devices 2360 attached to a network or network(s) 2350, such as other computer systems or devices. In various embodiments, network interface 2340 may support communication via any suitable wired or wireless general data networks, such as types of Ethernet networks, for example. Additionally, network interface 2340 may support communication via telecommunications/telephony networks such as analog voice networks or digital fiber communications networks, via storage area networks such as Fibre Channel SANs or via any other suitable type of network and/or protocol.

In some embodiments, system memory 2320 may be one embodiment of a computer-accessible medium configured to store program instructions and data as described above for FIGS. 1-7 for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 2300 via I/O interface 2380. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 2300 as system memory 2320 or another type of memory. Further, a computer-accessible medium may include transmission media or signals such as electrical, electromagnetic or digital signals, conveyed via a communication medium such as a network and/or a wireless link, such as may be implemented via network interface 2340. Portions or all of multiple computing devices, such as those illustrated in FIG. 23, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 23, may include other components that are not explicitly shown in FIG. 23, or may utilize an architecture completely different than that shown in FIG. 23.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A screen product comprising:
a screen configured to be removably received by a frame, the screen comprising:
a plurality of longitudinal threads that extend along a first direction; and
a plurality of widthwise threads that extend along a second direction that is perpendicular to the first direction;
an imprint;
wherein the longitudinal threads and the widthwise threads are configured to achieve a first transparency and the imprint achieves a second transparency that is different from the first transparency;
wherein the first and second transparencies are operable to produce a visually perceptible difference between the first and second transparencies when the screen product is viewed; and
wherein the screen product is configured to be used in a door or window opening to provide a visible indication of presence of the screen product due to differences in light attenuation by the first and second transparencies and not due to color or hue of the screen product.

2. The screen product of claim 1, further comprising a frame that defines an exterior portion.

3. The screen product of claim 1, wherein the imprint has a variation in density.

4. The screen product of claim 1, wherein the imprint is bonded to the screen using a heat set.

5. The screen product of claim 1, wherein the imprint is chemically bonded to the screen.

6. A screen product comprising:
a screen configured to be removably received by a frame, the screen comprising:
a plurality of longitudinal threads that extend along a first direction; and
a plurality of widthwise threads that extend along a second direction that is perpendicular to the first direction, wherein the longitudinal threads and the widthwise threads are weaved to form a mesh that includes a first pattern configured to achieve a first transparency, and wherein the mesh includes an imprint that is different from the first pattern and configured to achieve a second transparency that is different from the first transparency;
wherein the first and second transparencies are operable to produce a visually perceptible difference between the first and second transparencies when the screen product is viewed; and
wherein the screen product is configured to be used in a door or window opening to provide a visible indication of presence of the screen product due to differences in light attenuation by the first and second transparencies and not due to color or hue of the screen product.

7. An apparatus for preparing a screen product that includes:
a screen configured to be removably received by a frame, the screen comprising:
a plurality of longitudinal threads that extend along a first direction; and
a plurality of widthwise threads that extend along a second direction that is perpendicular to the first direction, wherein the longitudinal threads and the widthwise threads are weaved to form a mesh that includes a first pattern configured to achieve a first transparency;
an imprint that is different from the first pattern and configured to achieve a second transparency that is different from the first transparency;
wherein the first and second transparencies are operable to produce a visually perceptible difference between the first and second transparencies when the screen product is viewed; and
wherein the screen product is configured to be used in a door or window opening to provide a visible indication of presence of the screen product due to differences in light attenuation by the first and second transparencies and not due to color or hue of the screen product;
the apparatus comprising a heat press coupled to a measuring device;
the apparatus configured to:
receive an amount of unprocessed screen mesh;
receive a decal;
measure an amount of the unprocessed screen mesh; and
pressurize the heat press on the amount of the unprocessed screen mesh and the decal placed between the unprocessed screen mesh and the heat press to produce a processed screen mesh;
wherein the heat press is usable to bond the decal to the amount of unprocessed screen mesh.

8. The apparatus of claim 7, wherein the apparatus is further configured to roll the processed screen mesh for delivery.

9. A method of generating a screen product, the method comprising:
measuring an amount of unprocessed screen mesh;
placing a decal to be heat pressed between the amount of unprocessed screen mesh and a heat press; and
pressurizing the heat press onto the amount of unprocessed screen mesh and the decal to produce a processed screen mesh;
wherein the heat press is operable to bond the decal to the amount of the unprocessed screen mesh.
